(19) United States
(12) Patent Application Publication
(10) Pub. No.: US 2014/0045048 A1
(43) Pub. Date: Feb. 13, 2014

(54) NONAQUEOUS ELECTROLYTE SECONDARY BATTERY

(71) Applicant: SANYO Electric Co., Ltd., Osaka (JP)

(72) Inventors: Yoshinori Yokoyama, Itano-gun (JP); Takayuki Hattori, Minamiawaji-shi (JP); Yasuhiro Yamaguchi, Sumoto-shi (JP)

(73) Assignee: SANYO Electric Co., Ltd., Osaka (JP)

(21) Appl. No.: 13/961,951

(22) Filed: Aug. 8, 2013

(30) Foreign Application Priority Data
Aug. 9, 2012 (JP) 2012-176793

(51) Int. Cl. H01M 10/0567; H01M 2/30

(52) U.S. Cl. CPC H01M 10/0567; H01M 2/30
USPC 429/179

(57) ABSTRACT

A nonaqueous electrolyte secondary battery includes an electrode assembly, a nonaqueous electrolyte, and a container. The electrode assembly includes a positive electrode, a negative electrode, and a separator. The negative electrode is opposed to the positive electrode. The separator is disposed between the positive electrode and the negative electrode. The nonaqueous electrolyte contains lithium difluorophosphate. The container houses the electrode assembly and the nonaqueous electrolyte. The container has a positive electrode terminal and a negative electrode terminal on one end face. The container is roughly parallelepiped in shape. The ratio (height dimension/length dimension) of the height dimension of the container to its length dimension viewed from the front is not more than 0.5.

### TECHNICAL FIELD

The present invention relates to a nonaqueous electrolyte secondary battery.

### BACKGROUND ART

In recent years, there have been various endeavors to use nonaqueous electrolyte secondary batteries in, for example, electric vehicles, hybrid cars, and the like. In such applications, the batteries are required to have superior storage characteristics in addition to high output.

For example, JP-A-11-67270 discloses that the storage characteristics of a nonaqueous electrolyte secondary battery are improved by adding lithium difluorophosphate to its nonaqueous electrolyte.

The inventors have discovered, as a result of diligent researches, that although the low-temperature output characteristics of nonaqueous electrolyte secondary batteries are improved when lithium difluorophosphate is added to their nonaqueous electrolyte, their storage characteristics might decline.

### SUMMARY

A principal advantage of some aspects of the invention is to provide a nonaqueous electrolyte secondary battery in which the low-temperature output characteristics are improved and moreover the storage characteristics are not prone to decline.

A nonaqueous electrolyte secondary battery of an aspect of the invention includes an electrode assembly, a nonaqueous electrolyte, and a container. The electrode assembly includes a positive electrode, a negative electrode, and a separator. The negative electrode is opposed to the positive electrode. The separator is disposed between the positive electrode and the negative electrode. The nonaqueous electrolyte contains lithium difluorophosphate. The container houses the electrode assembly and the nonaqueous electrolyte. The container has a positive electrode terminal and a negative electrode terminal on one end face. The container is roughly parallelepiped in shape. The ratio (height dimension/length dimension) of the height dimension of the container to its length dimension viewed from the front is not more than 0.5.

The invention can provide a nonaqueous electrolyte secondary battery in which the low-temperature output characteristics are not prone to decline.

### BRIEF DESCRIPTION OF THE DRAWINGS

The invention will be described with reference to the accompanying drawings, wherein like numbers reference like elements.

FIG. 1 is a simplified perspective view of a nonaqueous electrolyte secondary battery according to an embodiment of the invention.

FIG. 2 is a simplified sectional view through line II-II in FIG. 1.

FIG. 3 is a simplified sectional view through line III-III in FIG. 1.

FIG. 4 is a simplified sectional view through line IV-IV in FIG. 1.

FIG. 5 is a simplified sectional view of part of the electrode assembly in an embodiment of the invention.

### DESCRIPTION OF EXEMPLARY EMBODIMENTS

A preferred embodiment that implements the invention will now be described with reference to the accompanying drawings. However, the following embodiment is merely an illustrative example and does not limit the invention in any way.

In the accompanying drawings, to which reference will be made in describing the embodiment and other matters, members that have substantially the same functions are assigned the same reference numerals throughout. In addition, the accompanying drawings, to which reference will be made in describing the embodiment and other matters, are schematic representations, and the proportions of the dimensions of the objects depicted in the drawings may differ from the proportions of the dimensions of the actual objects. The proportions of the dimensions of the objects may differ among the drawings. The concrete proportions of the dimensions, of the objects should be determined in view of the following description.

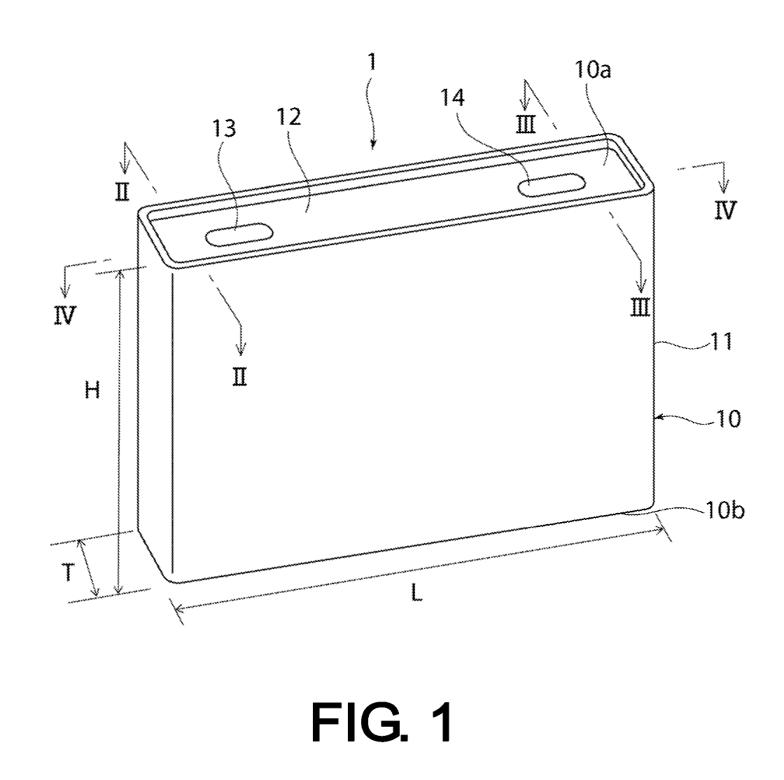

A nonaqueous electrolyte secondary battery 1 shown is FIG. 1 is a prismatic nonaqueous electrolyte secondary battery. However, a nonaqueous electrolyte secondary battery of the invention could alternatively be cylindrical, flattened, or otherwise shaped. The nonaqueous electrolyte secondary battery 1 can be used for any kind of application, and will preferably be used, in an electric vehicle and a hybrid vehicle, for example. The capacity of the nonaqueous electrolyte secondary battery 1 is not less than 15 Ah, further preferably not less than 18 Ah, and still further preferably not less than 20 Ah. Normally, the capacity of the nonaqueous electrolyte secondary battery 1 will be not more than 50 Ah.

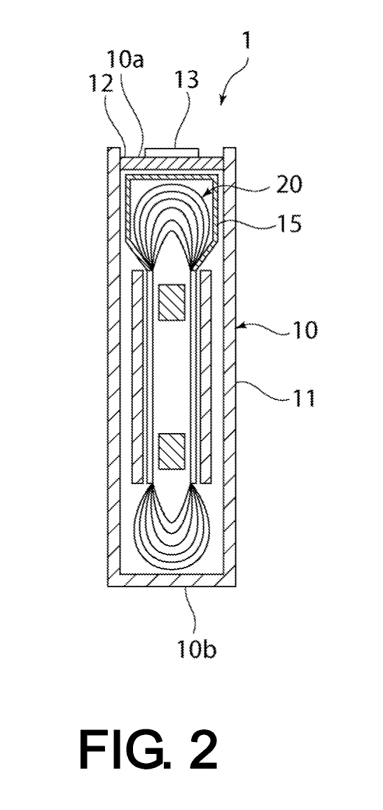

The “battery capacity” in this case means the capacity of the battery when the battery has been charged at a constant current of 1 It to a voltage of 4.1 V, then charged for 1.5 hours at a constant voltage of 4.1V, and then discharged at a constant current of 1 It to a voltage of 2.5 V. The nonaqueous electrolyte secondary battery I includes a container 10 shown in FIGS. 1 to 4, and an electrode assembly 20 shown, in FIGS. 2 to 5. The nonaqueous electrolyte secondary battery 1 is a prismatic nonaqueous electrolyte secondary battery in which the container 10 is roughly parallelepiped in shape.

The container 10 has a container body 11 and a sealing plate 12. The container body 11 is provided in the form of a rectangular tube of which one end is closed. In other words, the container body 11 is provided in the form of a bottomed square tube. The container body 11 has an opening. This opening is sealed up by the sealing plate 12. Thereby, the interior space approximately parallelepiped is formed into a compartment. The electrode assembly 20 and the nonaqueous electrolyte are housed in this interior space.

A positive electrode terminal 13 and a negative electrode terminal 14 are connected to the sealing plate 12. The positive electrode terminal 13 and the negative electrode terminal 14 are each electrically insulated from the sealing plate 12 by insulating material not shown in the drawings. The positive electrode terminal 13 and the negative electrode terminal 14 are both provided on one end face 10a in the height direction of the container 10.

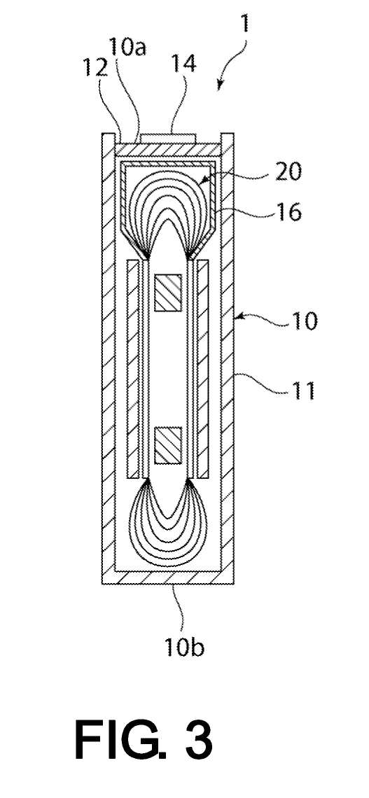

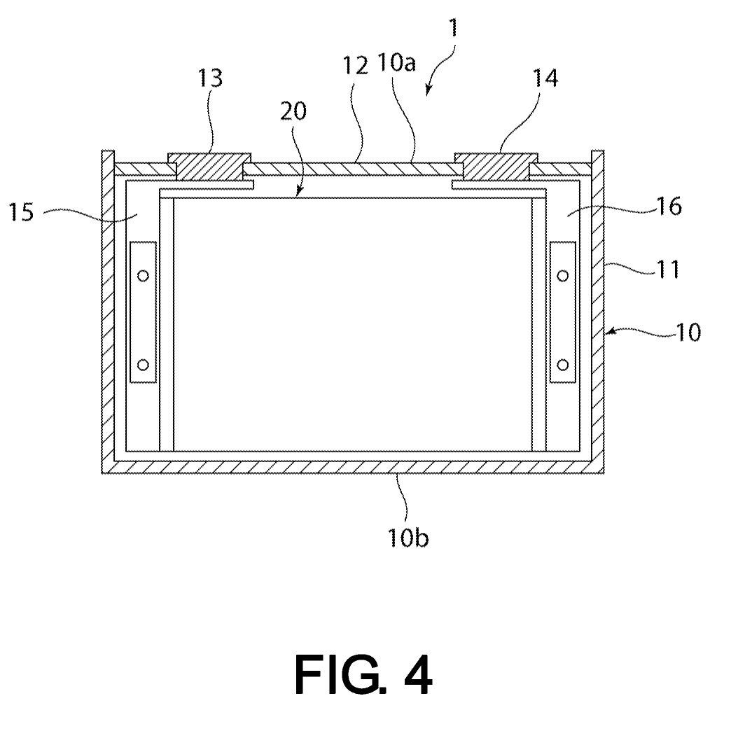

As shown in FIGS. 2 and 4, the positive electrode terminal 13 is electrically connected to a positive electrode substrate 21a of a positive electrode 21 by positive electrode collector 15. The positive electrode collector 15 can be formed of aluminum, an aluminum alloy, or other materials. As shown in FIGS. 2 and 3, the negative electrode terminal 14 is electrically connected to a negative electrode substrate 22a of a negative electrode 22 by negative electrode collector 16. The negative electrode collector 16 can be formed of copper, a copper alloy, or other materials.

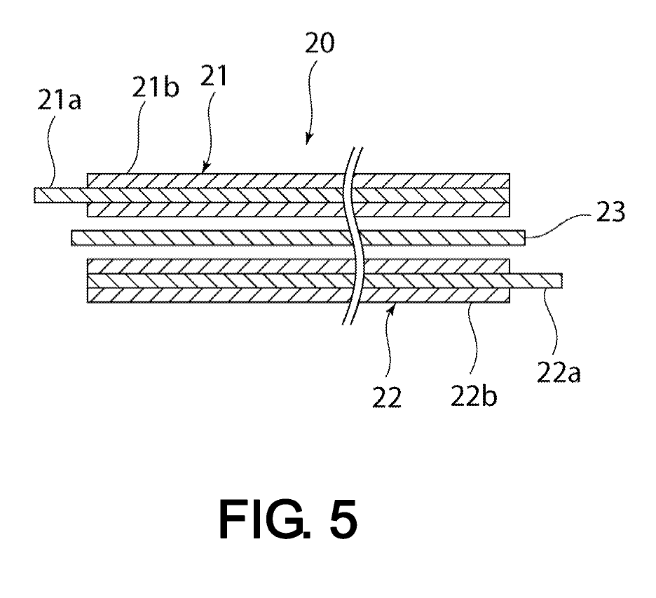

As shown in FIG. 5, the electrode assembly 20 includes the positive electrode 21, the negative electrode 22, and a separator 23. The positive electrode 21 and the negative electrode 22 are opposed to each other. The separator 23 is disposed between the positive electrode 21 and the negative electrode 22. The positive electrode 21, the negative electrode 22, and the separator 23 are wound and then pressed into a flattened shape. In other words, the electrode assembly 20 includes a flat wound positive electrode 21, the negative electrode 22, and the separator 23.

The positive electrode 21 includes a positive electrode substrate 21a and a positive electrode active material layer 21b. The positive electrode substrate 21a can be formed of aluminum, an aluminum alloy, or other materials. The positive electrode active material layer 21b is provided on at least one surface of the positive electrode substrate 21a. The positive electrode active material layer 21b contains a positive electrode active material. An example of the positive electrode active material that will preferably be used is a lithium oxide containing at least one of cobalt, nickel, and manganese. The following shows specific examples of such a lithium oxide containing at least one of cobalt, nickel, and manganese: lithium-containing nickel-cobalt-manganese complex oxides (LiNiₓCo_{y}Mn_{z}O₂, x+y+z=1, 0≦x≦1, 0≦y≦1, 0≦z≦1); lithium cobalt oxide (LiCoO₂); lithium manganese oxide (LiMn₂O₄); lithium nickel oxide (LiNiO₂); and a lithium-containing transition metal complex oxide such as a compound obtained by replacing part of the transition metal contained in these oxides with another element. Of these, lithium-containing nickel-cobalt-manganese complex oxides (LiNiₓCo_{y}Mn_{z}O₂, x+y+z=1, 0≦x≦1, 0≦y≦1, 0≦z≦1) and a lithium-containing transition metal complex oxide such as a compound obtained by replacing part of the transition metal contained in such oxide with another element will further preferably be used as the positive electrode active material. The positive electrode active material layer 21b may contain another component such as conductive material and binder as appropriate in addition to the positive electrode active material.

The negative electrode 22 includes a negative electrode substrate 22a and a negative electrode active material layer 22b. The negative electrode substrate 22a can be formed of copper, a copper alloy, or other materials. The negative electrode active material layer 22b is provided on at least one surface of the negative electrode substrate 22a. The negative electrode substrate 22a contains negative electrode active material. There is no particular limitation on the negative electrode active material, provided that it is able to reversibly absorb and desorb lithium. Examples of the negative electrode active material that will preferably be used are: carbon material, material that alloys with lithium, and metal oxide such as tin oxide. The following specific examples of carbon material can be cited: natural graphite, artificial graphite, mesophase pitch-based carbon fiber (MCF), mesocarbon microbeads (MCMB), coke, hard carbon, fullerene, and carbon nanotubes. Examples of material that can alloy with lithium, are: one or more metals selected from the group consisting of silicon, germanium, tin, and aluminum, or an alloy containing one or more metals selected from, the group consisting of silicon, germanium, tin, and aluminum. Of these, natural graphite, artificial graphite, and mesophase pitch-based, carbon fiber (MCF) will preferably be used as the negative electrode active material. The negative electrode active material layer 22b may contain another component such as conductive material and binder as appropriate in addition to the negative electrode active material.

The separator can he formed of a porous sheet of plastic such as polyethylene and polypropylene.

The electrode assembly 20 is housed inside the container 10. The nonaqueous electrolyte is also housed inside the container 10. The nonaqueous electrolyte contains lithium difluorophosphate (LiPO₂F₂) as solute. Adding lithium difluorophosphate to the nonaqueous electrolyte enables raising of the storage characteristics of the nonaqueous electrolyte secondary battery 1.

To raise the storage characteristics of the nonaqueous electrolyte secondary battery 1 while improving the low-temperature output characteristics, the content of lithium difluorophosphate in the nonaqueous electrolyte will preferably be not less than 0.01 mol/L, and more preferably will be not less than 0.03 mol/L. Normally, the content of lithium, difluorophosphate in the nonaqueous electrolyte will be not more than 0.1 mol/L.

The preferable content ranges for the lithium difluorophosphate are standard values for the nonaqueous electrolyte in the nonaqueous electrolyte secondary battery immediately after assembly and before the first charging. The reason for providing such standard values is that when a nonaqueous electrolyte secondary battery containing lithium difluorophosphate is charged, the content level gradually declines. The cause of this is surmised to be that during charging, part of the lithium difluorophosphate is consumed in formation of film on the negative electrode.

In addition to lithium difluorophosphate, the nonaqueous electrolyte may contain as solute a substance such as: LiXF_{y} (where X is P, As, Sb, B, Bi, Al, Ga, or In, and y is 6 when X is P, As, or Sb, and y is 4 when X is B, Bi, Al, Ga, or In); lithium perfluoroalkyl sulfonic acid imide LiN(CₘF₂ₘ₊₁SO₂) (CₙF₂ₙ₊₁SO₂) (where m and n are independently integers from 1 to 4); lithium perfluoroalkyl sulfonic acid methide LiC(CₚF₂ₚ₊₁SO₂) (C_{q}F_{2q+1}SO₂) (CᵣF₂ᵣ₊₁SO₂) (where p, q, and r are independently integers from 1 to 4); LiCF₃SO₃; LiClO₄; Li₂B₁₀Cl₁₀; and Li₂B₁₂Cl₁₂. Of these, the nonaqueous electrolyte may contain, as solute, at least one of LiPF₆, LiBf₄, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, and lithium bis(oxalato)botate (LiBOB), for example. It will suffice for LiBOB to be present in the electrolyte immediately after the nonaqueous electrolyte secondary battery has been assembled. For example, after charge-discharge has been performed following assembly, the LiBOB may in some cases be present in the form of a LiBOB alteration. In other cases, at least a part of the LiBOB or the LiBOB alteration may be present on the negative electrode active material layer. Such cases are included in the technical scope of the invention.

It is particularly preferable that the nonaqueous electrolyte contain lithium bis(oxalato)borate (LiBOB), since the cycling characteristics will be enhanced.

The content of LiBOB in the nonaqueous electrolyte will preferably be not less than 0.05 mol/L, more preferably will be not less than 0.08 mol/L, and still more preferably will be not less than 0.10 mol/L. However, if the content of LiBOB in the nonaqueous electrolyte is too high, the nonaqueous electrolyte secondary battery could heat up too much in the event of battery trouble. In addition, the battery characteristics could decline due to increase in the battery internal resistance. Hence, the content of LiBOB in the nonaqueous electrolyte of the nonaqueous electrolyte secondary battery 1 will preferably be not more than 2 mol/L, and further preferably not more than 1 mol/L.

The preferable content range for LiBOB is based on the nonaqueous electrolyte in the nonaqueous electrolyte secondary battery immediately after assembly and before the first charging. The reason for providing such basis is that when a nonaqueous electrolyte secondary battery containing LiBOB is charged, its content level gradually declines. The cause of this is supposed to be that during charging, part of the LiBOB is consumed in formation of a covering on the negative electrode.

The nonaqueous electrolyte may contain as solvent, for example, cyclic carbonate, chain carbonate, or a mixture of cyclic carbonate and chain carbonate. Specific examples of cyclic carbonate are ethylene carbonate, propylene carbonate, butylene carbonate, and vinylene carbonate. Specific examples of chain carbonate are dimethyl carbonate, methyl ethyl carbonate, and diethyl carbonate.

Nonaqueous electrolyte secondary batteries that are used in, for example, electric vehicles, hybrid vehicles, and the like are required to have not only high storage characteristics but also high output characteristics at low temperatures, since they are used in cold regions as well as other regions. As mentioned above, the inventors have discovered, as a result of diligent researches, that although the low-temperature output characteristics of nonaqueous electrolyte secondary batteries are improved when lithium difluorophosphate is added to their nonaqueous electrolyte, their storage characteristics might decline. As a result of further diligent researches, it has become clear that, due to heat-up during charging and discharging, a nonaqueous electrolyte secondary battery will be warmed up in the vicinity of the positive electrode terminal and the negative electrode terminal provided on one end face in the height direction of the container; but in cold regions, the container might be cooled through the bottom surface in the vicinity of the opposite end face to the end face where the positive electrode terminal and the negative electrode terminal are provided, and the temperature of the nonaqueous electrolyte secondary battery might become low. When the battery inside has temperature variation because the battery has places where the temperature is partially high and places where it is low in the foregoing manner, the electrode assembly of the nonaqueous electrolyte secondary battery might deteriorate and the storage characteristics decline.

In the nonaqueous electrolyte secondary battery 1 of this embodiment, the ratio (height dimension H/length dimension L) of the height dimension H of the container to its length dimension L viewed from the front is not more than 0.5. This leads to a short distance between the end face 10a in the height direction where the positive electrode terminal 13 and the negative electrode terminal 14 are disposed, and another end face 10b in the height direction located at the opposite side from the end face 10a, and so heat generated in the vicinity of the positive electrode terminal 13 and the negative electrode terminal 14 will readily reach the end face 10b. Consequently, temperature irregularity (variation) will not be prone to occur. Thanks to this, partial low temperature is prevented in the nonaqueous electrolyte secondary battery 1, and thus the storage characteristics are improved. To further improve the storage characteristics of the nonaqueous electrolyte secondary battery 1, the ratio (height dimension H/length dimension L) of the height dimension H of the container 10 to its length dimension viewed from the front will preferably be not less than 0.2 and not more than 0.5, and more preferably will be not less than 0.3 and not more than 0.5.

To further improve the storage characteristics, the length dimension L of the container 10 wilt preferably be 100 to 200 mm, the height dimension H of the container 10 will preferably be 50 to 100 mm, and the thickness dimension T of the container 10 will preferably be 10 to 30 mm.

What is claimed is:

1. A nonaqueous electrolyte secondary battery, comprising:
an electrode assembly including a positive electrode, a negative electrode opposed to the positive electrode, and a separator disposed between the positive electrode and the negative electrode;
a nonaqueous electrolyte containing lithium difluorophosphate; and
a container housing the electrode assembly and the nonaqueous electrolyte, and having a positive electrode terminal and a negative electrode terminal on one end face,
the container being roughly parallelepiped in shape, and the ratio (height dimension/length dimension) of the height dimension thereof to the length dimension thereof viewed from the front being not more than 0.5.

2. The nonaqueous electrolyte secondary battery according to claim 1, wherein the ratio (height dimension/length dimension) of the height dimension of the container to the length dimension thereof viewed from the front is not less than 0.2 and not more than 0.5.

3. The nonaqueous electrolyte secondary battery according to claim 1, wherein the content of the lithium difluorophosphate in the nonaqueous electrolyte is not less than 0.01 mol/L.

4. The nonaqueous electrolyte secondary battery according to claim 2, wherein the content of the lithium difluorophosphate in the nonaqueous electrolyte is not less than 0.01 mol/L.

5. The nonaqueous electrolyte secondary battery according to claim L wherein the nonaqueous electrolyte contains lithium bis(oxalato)borate.

6. The nonaqueous electrolyte secondary battery according to claim 2, wherein the nonaqueous electrolyte contains lithium bis(oxalato)borate.

7. The nonaqueous electrolyte secondary battery according to claim 5, wherein the content of the lithium bis(oxalato)borate in the nonaqueous electrolyte is not less than 0.05 mol/L.

8. The nonaqueous electrolyte secondary battery according to claim 6, wherein the lithium bis(oxalato)borate content in the nonaqueous electrolyte is not less than 0.05 mol/L.

9. The nonaqueous electrolyte secondary battery according to claim 1, wherein the capacity of the battery is not less than 15 Ah.

10. The nonaqueous electrolyte secondary battery according to claim 2, wherein the capacity of the battery is not less than 15 Ah.

11. The nonaqueous electrolyte secondary battery according to claim 3, wherein the capacity of the battery is not less than 15 Ah.

12. The nonaqueous electrolyte secondary battery according to claim 4, wherein, the capacity of the battery is not less than 15 Ah.

13. The nonaqueous electrolyte secondary battery according to claim 5, wherein the capacity of the battery is not less than 15 Ah.

14. The nonaqueous electrolyte secondary battery according to claim 6, wherein the capacity of the battery is not less than 15 Ah.

15. The nonaqueous electrolyte secondary battery according to claim 7, wherein the capacity of the battery is not less than 15 Ah.

16. The nonaqueous electrolyte secondary battery according to claim 8, wherein the capacity of the battery is not less than 15 Ah.
